(19) United States
(12) Patent Application Publication
(10) Pub. No.: US 2002/0026877 A1
(43) Pub. Date: Mar. 7, 2002

(54) Method and apparatus for applying information onto a workpiece

(75) Inventors: Andreas Grabotin, Heimsheim (DE); Joachim Greis, Stuttgart (DE); Uwe Piekert, Korntal-Munchingen (DE)

Correspondence Address: Dreiss, Fuhlendorf, Steimle & Becker, Patentanwalte, Postfach 10 37 62, Stuttgart, D-70032, DE

(73) Assignee: Tampoprint GmbH, Lingwiesenstr, Korntal-Munchingen (DE)

(21) Appl. No.: 09/985,969

(22) Filed: Nov. 7, 2001

Related U.S. Application Data
(63) Continuation of application No. 09/712,241, filed on Nov. 15, 2000.
Application No. 09/712,241 is a continuation of application No. 09/328,431, filed on Jun. 9, 1999, now abandoned.

(30) Foreign Application Priority Data
Apr. 25, 1997 (DE) 197 17 653.4

(51) Int. Cl. B41F 17/00; B41J 1/00

(52) U.S. Cl. 101/41; 101/43

(57) ABSTRACT

In a method and apparatus for applying information onto an object, the surface to be printed is roughened by means of a laser before the printing of the object with ink by means of a pad printing machine.

This application is a continuation of application Ser. No. 09/712,241 filed Nov. 15, 2000 which, in turn, is a continuation of application Ser. No. 09/328,431 filed Jun. 9, 1999 the complete disclosure of which are hereby incorporated by reference. Paris Convention priority of DE 197 17 653.4 filed Apr. 25, 1997 is also claimed.

### BACKGROUND OF THE INVENTION

The invention concerns a method for applying information onto a workpiece in the pad, or tampon, printing process. The invention also concerns an apparatus for performing this method using a transport unit for the workpieces to be processed and at least one pad printing machine.

Optimal printing results can be conventionally obtained using the pad printing process, particularly in the case of uneven or curved surfaces. In this way, for instance, spherical surfaces, cylinders, etc. can be provided with a printed image, which is taken from a planar cliche by a pad and transferred onto the workpiece. However, problems occur when printing smooth surfaces having a low roughness depth, such as glass surfaces, chromed and polished metal surfaces, and sanitary fittings, since the printing ink does not bond well to such surfaces and tends to flake off after a short period of use. In order to overcome this disadvantage, two component-inks have been used and were applied using a special process. However, even in this case, the bonding has been unsatisfactory.

In view of these problems in prior art, it is the object of the present invention to provide a method and apparatus with which even smooth surfaces of workpieces can be printed such that the ink will exhibit an optimum bond.

### SUMMARY OF THE INVENTION

This object is accomplished by the invention in a process of the above-described type by taking the following steps. The surface of the workpiece is roughened by means of a laser, at least in the region in the which the ink is to be applied, and the ink is then applied to the roughened surface by the printing pad.

In the method in accordance with the invention, at least the region where the ink is to be applied is roughened before the printing step, so that the subsequently applied ink can smoothly cover and bond better to the surface of the workpiece, particularly by at least partially engaging in recesses. The roughening is done by a laser, which transfers the profile of the image onto the location on the workpiece where the ink is to be applied. The laser is controlled by a suitable control unit, with the printing image, or rather the image to be engraved, being present as input in the form of data sets (e.g. CAD data). Since the printing ink is no longer applied to a smooth surface but rather to a roughened surface, a fundamentally better bond is obtained. As a result, ordinary ink can be used and no special precautions have to be met for the printing processes. Workpieces with smooth surfaces can now be printed just like workpieces with rough surfaces, e.g. workpieces made from plastic.

According to one particular feature of the process, the surface area roughened by the laser corresponds exactly to the image to be printed. In this case the initial roughening of the workpiece is not noticeable after printing. In another variation of the method, the surface roughened by the laser is larger than the image to be printed. In this case, the printed image is surrounded by an engraved border. This can e.g. prove to be aesthetically pleasing.

In addition to the roughening of the surface of the workpiece, the laser can also be used to engrave another region of the workpiece with writing, language symbols, alphanumeric characters or other information. For instance, in addition to the roughening, lines of writing can be engraved which are not printed on during the printing process. Both the roughening and the writing are advantageously done prior to the printing process.

According to a preferred embodiment of the invention, the surface is roughened to a depth of 1 to 20 micrometers and preferably 5 to 10 micrometers. In this embodiment, a chromium layer of a chromed workpiece is not penetrated by the roughening, since the normal chromium layer thickness is usually about 20 micrometers.

In accordance with a preferred embodiment of the invention, the surface is roughened by forming cross-hatching, i.e. parallel lines and/or the roughening structures may overlap to avoid or curtail unroughened surface area between adjacent lines or dots. The surface area receiving the printed image is therefore fully roughened.

The above-stated object of the invention is also achieved with an apparatus of the following kind. A laser station is provided, upstream of the pad printing machine, for roughening the surface of the workpiece. The workpieces, fed by way of a transport unit, first move through the laser station in which the workpieces are provided with the roughening, as discussed above. Conventional equipment can be thereby used.

A cleaning station may be advantageously provided between the laser station and the pad printing machine. Residues arising in the laser station during the engraving process are removed in this cleaning station. Also, as an additional measure, the entire area of the engraved surface can either be cleaned at the same time or pre-treated.

A drying station can be advantageously provided after the pad printing machine. The pad printing ink can be dried at this location using infrared light, UV-light, hot air, ultrasonics, etc., so that the workpiece can be taken out of the transport unit as quickly as possible and, e.g., sent to a packaging unit.

Particularly for the case of multi-ink printing, a special embodiment of the apparatus provides for a serial arrangement of a plurality of pad printing machines. In this case, the surface is roughened in the laser station and the overall complete image results from superposition of contributions from all the pad printing machines.

Other advantages, features and details can be extracted from the appended claims as well as from the following description, in which a preferred embodiment is explained in detail with reference to the drawing. Features shown in the drawing, stated in the claims, or disclosed in the description can be important to the invention, whether taken singly or in various combinations.

### BRIEF DESCRIPTION OF THE DRAWING

FIG. 1 schematically illustrates the apparatus of the present invention; and

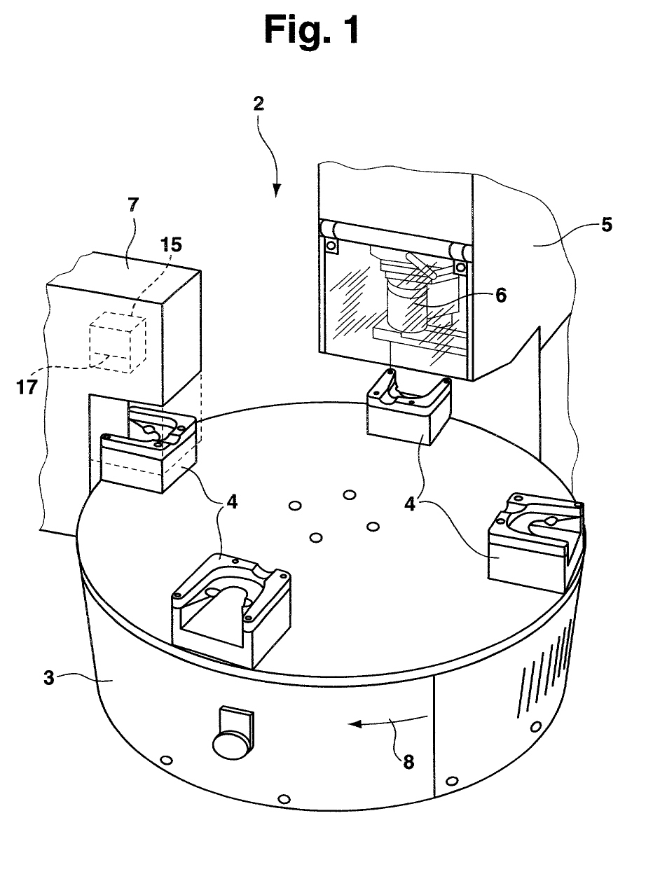

FIG. 2 schematically illustrates the cleaning station and the drying station with the apparatus of FIG. 1.

### DESCRIPTION OF THE PREFERRED EMBODIMENT

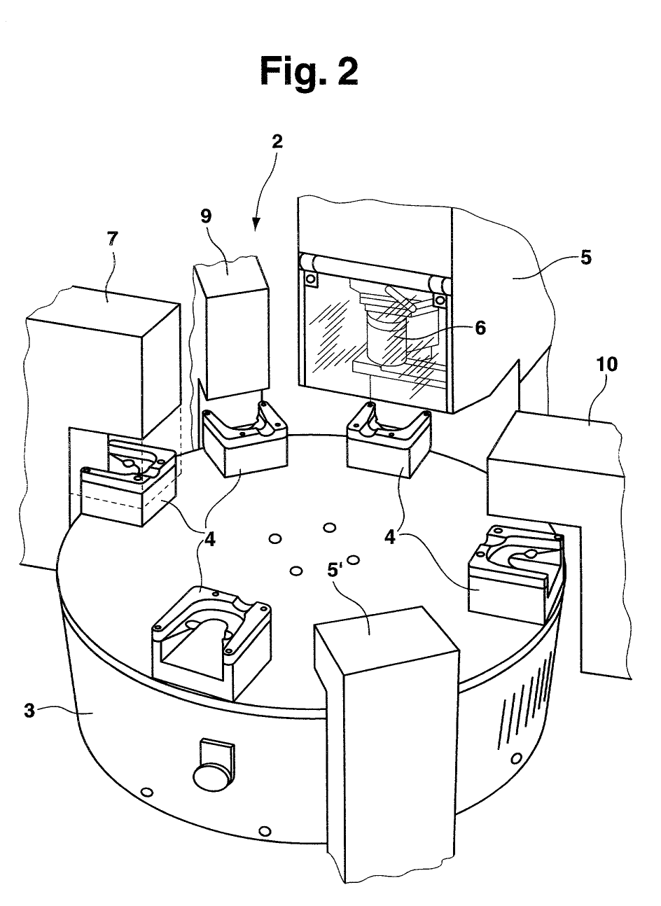

With reference to the embodiment illustrated in the drawing, the transport unit 1 of the apparatus 2 in accordance with the invention is constructed in the form of a rotary indexing plate, or table, and has four workpiece receiving stations 4 on its upper side (workpieces not shown). The rotary indexing plate 3 rotates in the clockwise direction, i.e. in the direction of arrow 8. Arranged alongside the rotary indexing plate 3 is a pad printing machine 5, which has a pad 6, which acts from above to print onto each presented workpiece. A laser station 7 is provided upstream of the pad printing machine 5. The surface of the object to be printed on is roughened by means of a laser at this location. Here, the laser is disposed in a similar sense as the printing pad in the pad printing machine 5, and acts on the workpiece in about the same direction as that of the printing process, namely from above. The roughened pattern applied to the workpiece by the laser station 7 is defined by a controller 15, programmed with an appropriate pattern via interface 17. A cleaning station 9 can be provided between the laser station 7 and the pad printing machine 5, in which the surface is freed of traces of residue. A drying station 10 can follow the pad printing machine. This drying station can be disposed opposite the laser station 7. Multiple printing can be effected with a series of printing stations one of which is schematically indicated with reference symbol 5′ in FIG. 2.

The apparatus of the invention permits the printing of workpieces with very smooth surfaces. The printed ink exhibits an optimal bonding to the workpiece, due to the preceding surface roughening.

We claim:

1. A method for applying information onto a work piece using a tampon printing process, the method comprising the steps of:
a) positioning the workpiece proximate a laser;
b) inputting an image data set to a controller, said image data set having a data set shape corresponding to a printed shape of subsequently applied ink;
c) controlling said laser with said controller to generate a first region on the workpiece to which ink is to be applied, said first region having a rough, uneven and irregular surface comprising a plurality of surface irregularities, said first region also having said data set shape;
d) applying ink to a tampon printing pad; and
e) printing, following steps b) through d), said first region with said tampon printing pad to transfer ink, having said printed shape, from said tampon printing pad to said first region, wherein said transferred ink has a non-zero thickness throughout said printed shape which varies within said first region to penetrate into and smoothly cover said surface irregularities.

2. The method of claim 1, wherein said first region corresponds in extent to an image to be printed.

3. The method of claim 1, wherein said first region is larger in extent than an image to be printed.

4. The method of claim 1, further comprising the step of engraving, using said laser, a second region with at least one of writing, language symbols, and alphanumeric characters.

5. The method of claim 4, wherein said treating and said engraving are done before said printing.

6. The method of claim 1, wherein said rough, uneven and irregular surface extends to a depth of 5 to 20 micrometers.

7. The method of claim 6, wherein said depth is 5 to 10 micrometers.

8. The method of claim 1, wherein said rough, uneven and irregular surface comprises at least one of overlapping cross-hatching and overlapping dots.

9. An apparatus for applying information onto a work piece using a tampon printing process, the apparatus comprising:
a) means for positioning the workpiece proximate a laser;
b) means for inputting an image data set to a controller, said image data set having a data set shape corresponding to a printed shape of subsequently applied ink;
c) means for controlling said laser with said controller to generate a first region on the workpiece to which ink is to be applied, said first region having a rough, uneven and irregular surface comprising a plurality of surface irregularities, said first region also having said data set shape;
d) means for applying ink to a tampon printing pad; and
e) means for printing, following steps b) through d), said first region with said tampon printing pad to transfer ink, having said printed shape, from said tampon printing pad to said first region, wherein said transferred ink has a non-zero thickness throughout said printed shape which varies within said first region to penetrate into and smoothly cover said surface irregularities.

10. The apparatus of claim 9, further comprising a cleaning station disposed between said printing means and said treating means.

11. The apparatus of claim 9, further comprising a drying station disposed downstream of said printing means.

12. The apparatus of claim 9, wherein said printing means comprises a plurality of printing machines arranged in series.

13. The apparatus of claim 9, wherein the work piece has a chrome-covered surface.

14. The apparatus of claim 9, wherein the work piece has a rounded surface contour.

15. The apparatus of claim 9, wherein the work piece is a chrome-covered, rounded, plumbing fixture.
